(19) United States
(12) Patent Application Publication
(10) Pub. No.: US 2011/0039436 A1
(43) Pub. Date: Feb. 17, 2011

(54) ELECTRICAL CONNECTOR HAVING IMPROVED LOCKING STRUCTURE

(75) Inventor: CHIA-WEI FAN, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/857,773

(22) Filed: Aug. 17, 2010

(30) Foreign Application Priority Data
Aug. 17, 2009 (TW) 98127519

(51) Int. Cl. H01R 13/62

(52) U.S. Cl. 439/296

(57) ABSTRACT

An electrical connector (100) includes a base (1) and a cover (3) covering on the base (1). The base includes a pair of first locking members (114, 115). The cover includes a pair of second locking members (314, 315). The cover slides along a horizontal direction from an unlocked position to a locked position to engage both second locking members with both first locking members of the base.

### BACKGROUND OF THE INVENTION

1. Field of the Invention

The present invention relates to an electrical connector having an improved locking structure adapted for locking the cover and base easily and reliably.

2. Description of Related Art

CN Patent No. 201247862 issued on May 27, 2009 discloses an electrical connector. The electrical connector comprises a base and a cover engaging with the base. The base comprises a pair of locking holes each having a locking portion formed therein. The cover comprises a pair of downwardly extending locking hooks. When the cover is mounted on the base, the locking hooks are inserted downwardly into the locking holes and engaged with the locking portions of the base to retain the cover on the base.

To obtain a reliable engagement between the locking hooks of the cover and the locking portions of the base, the size of the locking hooks may be increased. However, during mounting the cover to the base, the over-sized locking hooks will undergo large stress, resulting in unreliable engagement. In addition, it is inconvenient to put the cover onto the base with over-sized locking hooks.

Another known electrical connector comprises a base and a cover engaging with the base. The cover comprises a pair of opposite first side walls and a first opening between the first side walls. Each first side wall comprises a downwardly extending locking hook. The base comprises a pair of opposite second side walls and a second opening between the pair of second side walls. The second opening corresponds to the first opening. Each second side wall comprises a step portion. When the cover is driven along a horizontal direction from an unlocked position to a locked position to engage with the base, one of the locking hooks engages with a step portion while the other locking hook disengages or is separated from the other step portion.

With only one of the locking hooks of the cover engages with one step portion of the base, the assembly of the cover and the base is imbalance and unstable. In addition, if the locking hook of the cover is increased in size to achieve the balance of the assembly, such locking hook will be apt to damage.

Hence, an improved electrical connector is required to overcome the above-mentioned disadvantages of the related art.

### SUMMARY OF THE INVENTION

An object of the present invention is to provide an electrical connector that is easy to be driven to establish a reliable engagement between the cover and the base.

Another object of the present invention is to provide an electrical connector having a cover covering on a base stably.

To achieve the aforementioned object, an electrical connector comprises a base and a cover covering on the base. The base comprises a first locking member. The cover comprises a second locking member separated from the first locking member at an unlocked position. The cover slides along a first horizontal direction from said unlocked position to a locked position to drive the second locking member to lock with the first locking member of the base.

The cover slides along a first horizontal direction from the unlocked position to the locked position to drive the second locking member to lock with the first locking member of the base. It is hard to destroy the first and second locking members during the horizontally sliding movement. Therefore, the cover would lock with the base reliably. In addition, it is convenient to slide the cover on the base when the cover is needed to be locked with the base.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is an assembled perspective view of an electrical connector in accordance with the present invention;

FIG. 2 is an assembled perspective view of the cover and base as shown in FIG. 1, with the ram is being removed;

FIG. 3 is an exploded perspective view of the cover and base of the electrical connector as shown in FIG. 2;

FIG. 4 is a cross-sectional view of the cover and base disposed at an unlocked position, taken along line 5-5 of FIG. 2; and

FIG. 5 is a cross-sectional view of the cover and base at a locked position.

### DETAILED DESCRIPTION OF THE INVENTION

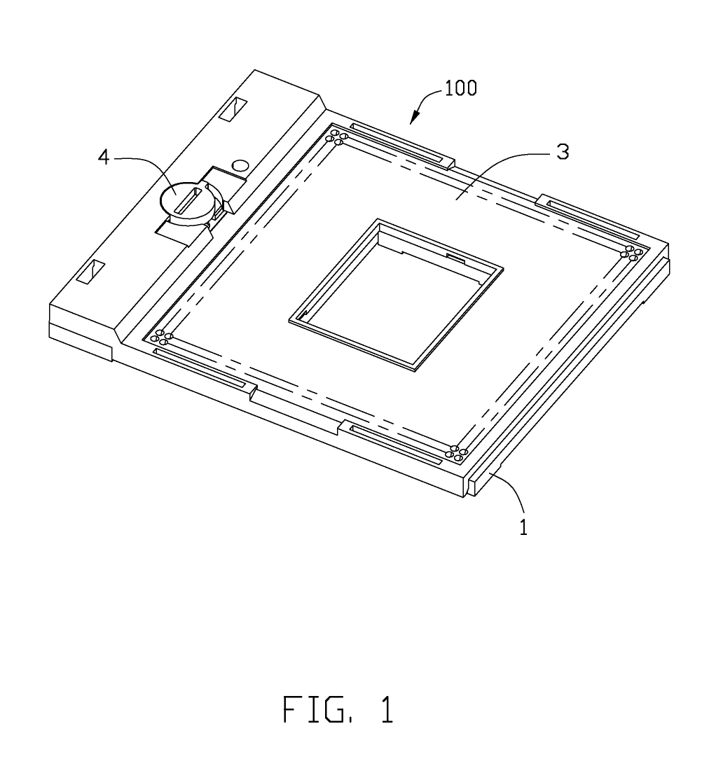

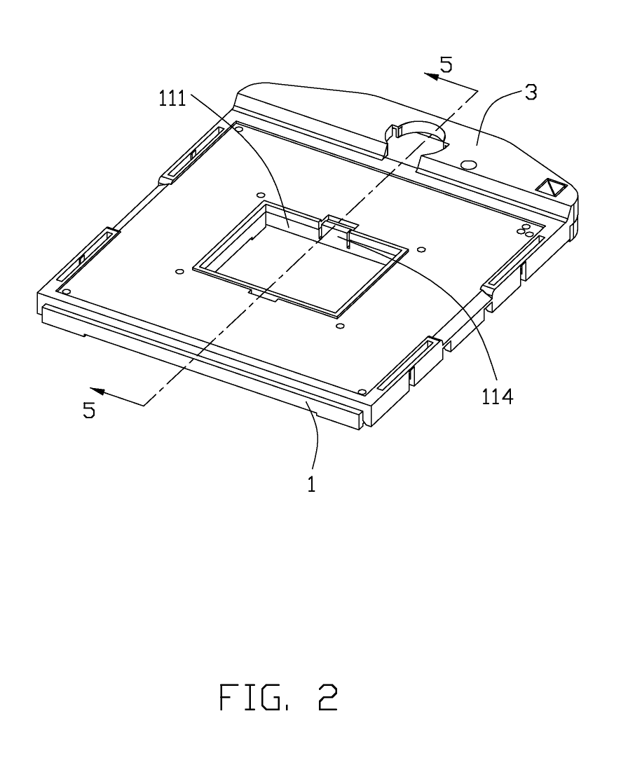

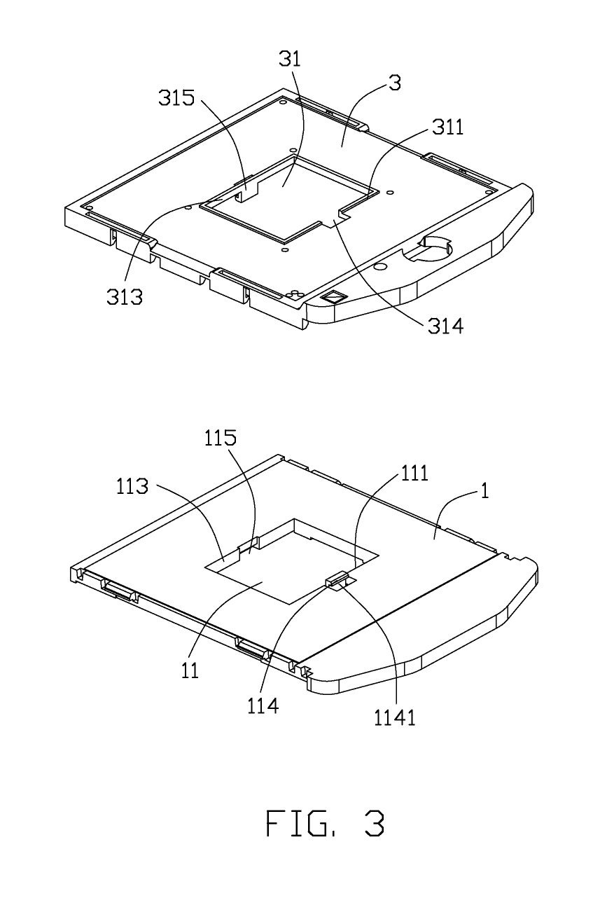

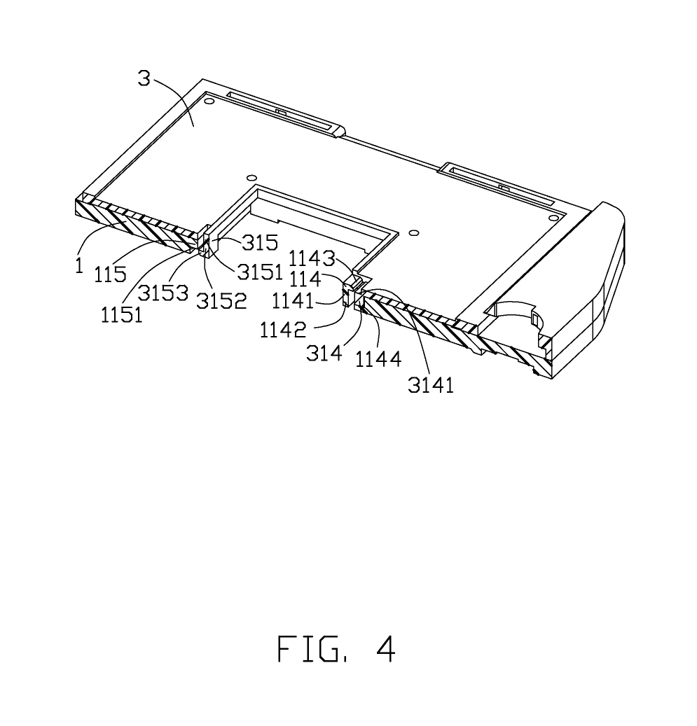

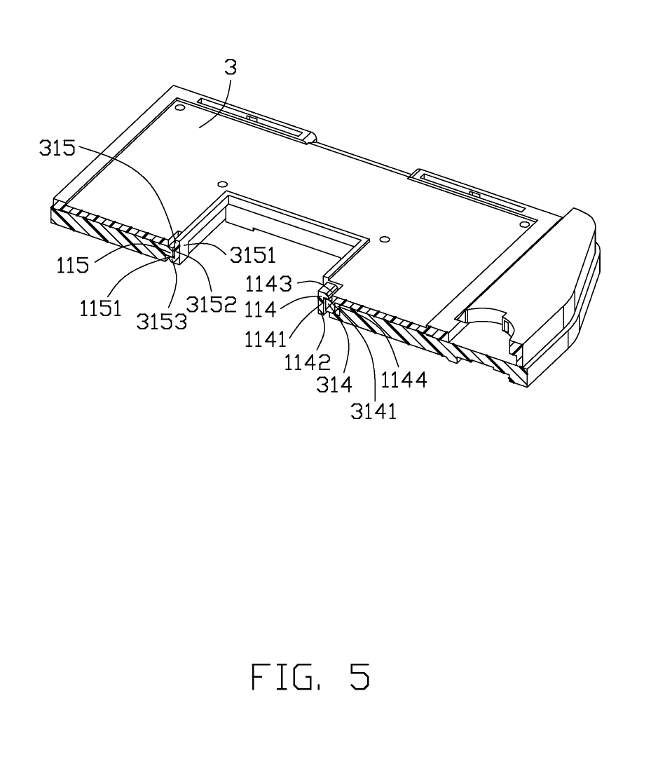

Reference will now be made to the drawing figures to describe the present invention in detail. Referring to FIGS. 1-5, an electrical connector 100 according to the present invention comprises a base 1, a plurality of terminals (not shown) received in the base 1, a cover 3 covering on the base 1, and a ram 4 received in the cover 3.

The base 1 comprises a first opening 11, a first front side wall 111 and a first rear side wall 113 opposite to the first front side wall 111. The first opening 11 is defined between the first front side wall 111 and the first rear side wall 113. The first front side wall 111 of the base 1 comprises a first front locking member 114. The first rear side wall 113 of the base 1 comprises a first rear locking member 115. The first front locking member 114 comprises a first elongated portion 1141 having a first arm 1142 extending along an upward direction perpendicular to the first horizontal direction and a first hook 1143 formed at a distal tail of the first arm 1142. The first front locking member 114 further comprises a recess 1144. The recess 1144 of the base 1 concaves from an upper surface of the base 1. The first elongated portion 1141 is disposed between the recess 1144 and the first opening 11. The first rear locking member 115 comprises a first step portion 1151. The first rear side wall 113 has a lower portion concaved upwardly to form the first step portion 1151.

The cover 3 comprises a second opening 31 corresponding to the first opening 11, a second front side wall 311 and a second rear side wall 313 opposite to the second front side wall 311. The second opening 31 is defined between the second front side wall 311 and the second rear side wall 313. The first front side wall 111 of the base 1 has a thickness greater than that of the second front side wall 311 of the cover 3. The first rear side wall 113 of the base 1 has a thickness greater than that of the second rear side wall 313 of the cover 3. The second front side wall 311 of the cover 3 comprises a second front locking member 314 is separated from the first front locking member 114 of the base 1 at an unlocked position. The second rear side wall 313 of the cover 3 comprises a second rear locking member 315 separated from the first rear locking member 115 of the base 1 at the unlocked position. The second front locking member 314 of the cover 3 comprises a second step portion 3141 engaging with the first hook 1143. The second front side wall 311 has a lower portion concaved downwardly to form the second step portion 3141. The second step portion 3141 is slidable in the recess 1144 between the unlocked position and the locked position. The second rear locking member 315 comprises a second elongated portion 3151 having a second arm 3152 extending along a downward direction perpendicular to the first horizontal direction and a second hook 3153 formed at a distal tail of the second arm 3152.

When the cover 3 is driven along a first horizontal direction from said unlocked position to a locked position to drive the second front locking member 314 to lock with first front locking member 114 and to drive the second rear locking member 315 to lock with the first rear locking member 115 of the base 1. The second hook 3153 engages with the first step portion 1151 of the base 1.

The cover 3 slides along a first horizontal direction from the unlocked position to the locked position to engage the second locking member with the first locking member of the base. In this structure, the first and second locking members is free from damage during the horizontal sliding movement. Therefore, the cover 3 would lock with the base 1 reliably. In addition, it is convenient to slide the cover 3 on the base 1 when the cover 3 is needed to be locked with the base 1.

However, the disclosure is only illustrative; changes may be made in detail, especially in matter of shape, size, and arrangement of parts within the principles of the invention.

What is claimed is:

1. An electrical connector comprising:
a base comprising a pair of first locking members;
a cover covering on the base and comprising a pair of second locking members, said cover being slidable relative to the base along a first horizontal direction from an unlocked position to a locked position to engage the second locking members with the first locking members of the base.

2. The electrical connector as claimed in claim 1, wherein said base comprises a pair of first side walls and a first opening between the pair of first side walls, and wherein said cover comprises a pair of second side walls and a second opening between the pair of second side walls.

3. The electrical connector as claimed in claim 2, wherein said first locking member is formed on the first side wall, and wherein the second locking member is formed on the second side wall.

4. The electrical connector as claimed in claim 3, wherein said first locking member of the base comprises a first elongated portion having a first arm extending along an upward direction perpendicular to the first horizontal direction and a first hook formed at a distal tail of the first arm, and wherein the second locking member of the cover comprises a second step portion.

5. The electrical connector as claimed in claim 4, wherein said base defines a recess concaved from an upper surface of the base, said first elongated portion is disposed between the recess and the first opening, and said second step portion of the cover is situated in the recess.

6. The electrical connector as claimed in claim 4, wherein said second step portion of the cover extends downwardly to a position lower than a bottom surface of the second side wall of the cover.

7. The electrical connector as claimed in claim 3, wherein said first locking member of the base comprises a first step portion, and wherein the second locking member of the cover comprises a second elongated portion having a second arm extending along a downward direction perpendicular to the first horizontal direction and a second hook formed at a distal tail of the second arm for engaging with the first step portion.

8. The electrical connector as claimed in claim 7, wherein said first side wall of the base has a lower portion concaved upwardly to form said first step portion.

9. The electrical connector as claimed in claim 3, wherein said first side wall of the base has a thickness greater than that of the second side wall of the cover.

10. The electrical connector as claimed in claim 3, wherein the pair of second locking members are separated from the pair of first locking members at the unlocked position.

11. An electrical connector for use with an electronic package, comprising:
an insulative base defining a lower center opening therein;
a plurality of contacts disposed in the base;
an insulative cover mounted to the base and back and forth moveable relative to the base in a front-to-back direction between opposite front loading and rear loaded positions and defining therein an upper center opening which is roughly aligned with the lower center opening in a vertical direction perpendicular to said front-to-back direction;
a plurality of through holes formed in the cover for receiving corresponding pins of said electronic package;
a front locking member unitarily upwardly from the base around an front inner edge of the lower center opening and defining a hook at an upper end; and
a front locking recess formed in the cover around a front inner edge of the upper center opening to receive said hook of said front locking member when said cover is moved to the rear loaded position relative to the base.

12. The electrical connector as claimed in claim 11, wherein the front locking member is essentially free from the locking recess when said cover is moved to the front loading position relative to the base.

13. The electrical connector as claimed in claim 11, wherein said cover further includes a downward locking member around a rear inner edge of the upper center opening, and the base further includes a locking recess around a rear inner edge of the lower center opening to receive said downwardly locking member when said cover is moved to the rear locked position relative to the base.

14. The electrical connector as claimed in claim 13, wherein the rear locking member is essentially free from the locking recess of the base when said cover is moved to the front loading position relative to the base.

15. The electrical connector as claimed in claim 13, wherein said front locking member and said rear locking member are aligned with each other in said front-to-back direction.

16. An electrical connector for use with an electronic package, comprising:
an insulative base defining a lower center opening therein;
a plurality of contacts disposed in the base;
an insulative cover mounted to the base and back and forth moveable relative to the base in a front-to-back direction between opposite front loading and rear loaded positions and defining therein an upper center opening which is roughly aligned with the lower center opening in a vertical direction perpendicular to said front-to-back direction so that said lower center opening and said upper center opening commonly define a combined center opening;
a plurality of through holes formed in the cover for receiving corresponding pins of said electronic package;
a front locking mechanism formed on a front inner edge of the combined center opening; and
a rear locking mechanism formed on a rear inner edge of the combined center opening; wherein
both said front locking mechanism and said rear locking mechanism are to lock the cover and the base together in the vertical direction when said cover is moved to the rear locked position relative to the base.

17. The electrical connector as claimed in claim 16, wherein both said front locking mechanism member and said rear locking mechanism are to unlock the cover and the base from each other in the vertical direction when said cover is moved to the front locked position relative to the base.

18. The electrical connector as claimed in claim 16, wherein said front locking mechanism and said rear locking mechanism are aligned with each other in said front-to-back direction.

19. The electrical connector as claimed in claim 16, wherein each of said front locking mechanism and said rear locking mechanism includes a locking hook formed on one of the cover and the base, and a locking recess formed in the other of said cover and said base.
